(19) United States
(12) Patent Application Publication
(10) Pub. No.: US 2016/0350405 A1
(43) Pub. Date: Dec. 1, 2016

(54) SEARCHING USING POINTERS TO PAGES IN DOCUMENTS

(71) Applicant: Linkedln Corporation, Mountain View, CA (US)

(72) Inventors: Arun Janakiraman, Mountain View, CA (US); Sumanth Kolar, Mountain View, CA (US); Benjamin N. Silver, Mountain View, CA (US)

(73) Assignee: Linkedln Corporation, Mountain View, CA (US)

(21) Appl. No.: 14/727,577

(22) Filed: Jun. 1, 2015

(51) Int. Cl. G06F 17/30

(52) U.S. Cl. CPC G06F 17/30675; G06F 17/3071

(57) ABSTRACT

In order to facilitate access to pages in documents, a system may ingest pointers that specify the pages in the documents from hypertext documents on a network, and may aggregate the ingested pointers in an index. For example, the index may be aggregated based on keywords in content in the documents, metadata associated with the documents and/or presentation formats of the pages. Then, when the system receives a search query, the system may identify a match in the pointers in the index based on the search query and the keywords, the metadata and/or the presentation formats in the index. Next, the system may provide a link with a pointer in the index based on the match. When the system receives information specifying activation of the link, the system may access a page in a document associated with a hypertext document, without extracting or copying the page.

### CROSS-REFERENCE TO RELATED APPLICATION

This application is related to U.S. Non-provisional application Ser. No. ______, entitled “Intra-Document Search,” by Arun Janakiraman and Sumanth Kolar (Attorney Docket Number LI-P1492.SLD.US), filed on 1 Jun., 2015, the contents of which are herein incorporated by reference.

### BACKGROUND

Field

The described embodiments relate to techniques for searching for content. More specifically, the described embodiments relate to techniques for using pointers to search for pages in documents.

Related Art

The popularity of the Internet has resulted in a significant increase in the amount of information available to individuals. Search engines are common tools to help individuals sort and identify relevant or interesting information for a particular topic. For example, an individual may provide a search query to a search engine, which then compares the search query (or a search expression based on the search query) to an indexed corpus of documents (such as the content on web pages and websites on the Internet), which may include a wide variety of information. Based on matches between documents in the corpus and the search query (or the search expression), the search engine then returns a set of results, including one or more potentially relevant documents.

However, the search results are often restricted to whole documents. It is typically difficult to search content within the documents, which is frustrating for individuals, and degrades the quality of their user experience.

### BRIEF DESCRIPTION OF THE FIGURES

FIG. 1 is a block diagram illustrating a system used to search pages in documents in accordance with an embodiment of the present disclosure.

FIG. 2 is a flow chart illustrating a method for searching pages in documents in accordance with an embodiment of the present disclosure.

FIG. 3 illustrates communication between the electronic devices of FIG. 1 in accordance with an embodiment of the present disclosure.

FIG. 4 illustrates a summary page summarizing search results in accordance with an embodiment of the present disclosure.

FIG. 5 is a block diagram illustrating a system used to search pages in documents in accordance with an embodiment of the present disclosure.

FIG. 6 is a flow chart illustrating a method for searching pages in documents in accordance with an embodiment of the present disclosure.

FIG. 7 illustrates communication between the electronic devices of FIG. 5 in accordance with an embodiment of the present disclosure.

FIG. 8 is a block diagram illustrating a computer system that performs the method of FIGS. 2 and 3 in accordance with an embodiment of the present disclosure.

FIG. 9 is a block diagram illustrating a computer system that performs the method of FIGS. 6 and 7 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In order to facilitate access to pages in documents (such as slides in presentations and/or frames in videos), in some embodiments a system creates pointers specifying the pages in the documents, and aggregates the pointers in an index. For example, the index may be aggregated based on keywords in content in the documents, metadata associated with the documents and/or presentation formats of the pages. Then, when the system receives a search query, the system may identify a match in the pointers in the index based on the search query and the keywords, the metadata and/or the presentation formats in the index. Next, the system may provide a pointer in the index based on the match. This pointer may allow a page in a document to be accessed while the page is included in the document, without having to access other pages or portions of the document.

Alternatively, in some other embodiments a system ingests pointers that specify the pages in the documents from hypertext documents on a network, and aggregates the ingested pointers in an index. For example, the index may be aggregated based on keywords in content in the documents, metadata associated with the documents and/or presentation formats of the pages. Then, when the system receives a search query, the system may identify a match in the pointers in the index based on the search query and the keywords, the metadata and/or the presentation formats in the index. Next, the system may provide a link with a pointer in the index based on the match. When the system receives information specifying activation of the link, the system may access a page in a document associated with a hypertext document, where the page is included in the document.

Therefore, a search technique disclosed herein may allow users to search for content within documents. In particular, the users may directly access individual pages in the documents, as opposed to accessing a particular document in a conventional manner (e.g., at page 1) and then navigating to a page that is of interest. In addition, the search technique may allow the pages to remain included in or associated with the documents, which may simplify the system and reduce storage expense that would be incurred in extracting or copying the pages. Consequently, the search technique may reduce the cost of the system and may reduce user frustration and, thus, may improve the user experience when using the system. Therefore, the search technique may increase user engagement with or use of the system.

In the discussion that follows, an individual or a user may be a person (for example, an existing user of a social network or a new user of the social network). Also, or instead, the search technique may be used by an organization, a business, and/or a government agency. Furthermore, a ‘business’ should be understood to include for-profit corporations, non-profit corporations, groups (or cohorts) of individuals, sole proprietorships, government agencies, partnerships, etc.

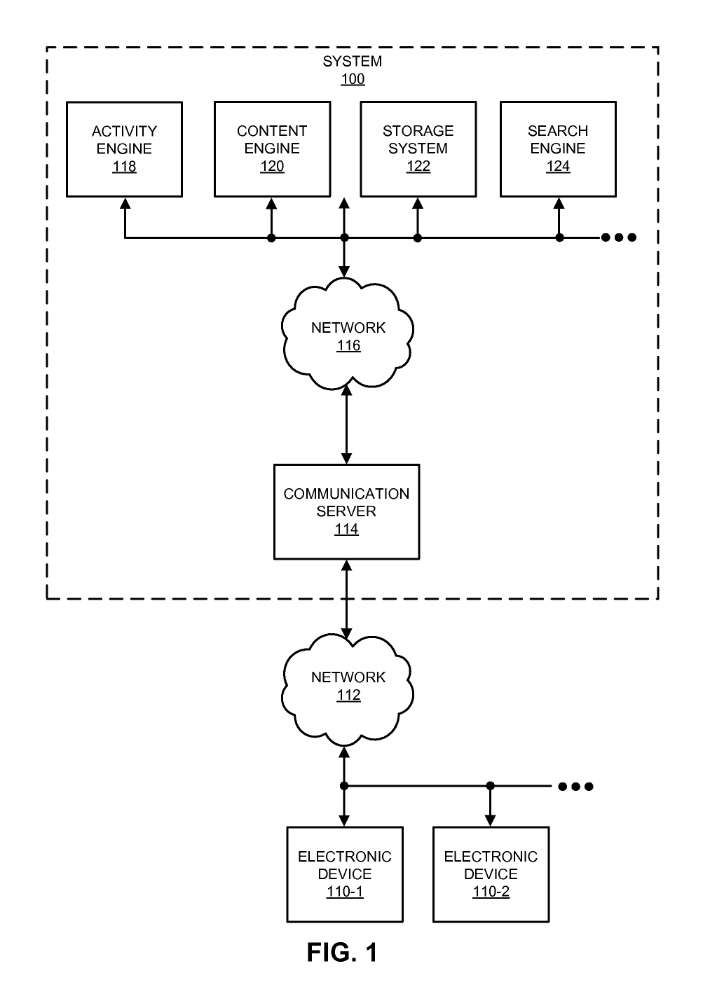

We now describe embodiments of the system and its use. FIG. 1 presents a block diagram illustrating a system 100 that performs the search technique. In this system, users of electronic devices 110 may use a software product, such as instances of a software application that is resident on and that executes on electronic devices 110. In some implementations, the users may interact with a web page that is provided by communication server 114 via network 112, and which is rendered by web browsers on electronic devices 110. For example, at least a portion of the software application executing on electronic devices 110 may be an application tool that is embedded in the web page, and that executes in a virtual environment of the web browsers. Thus, the application tool may be provided to the users via a client-server architecture.

The software application operated by the users may be a standalone application or a portion of another application that is resident on and that executes on electronic devices 110 (such as a software application that is provided by communication server 114 or that is installed on and executes on electronic devices 110).

Using one of electronic devices 110 (such as electronic device 110-1) as an illustrative example, a user of electronic device 110-1 may use the software application to interact with other users in a social network (and, more generally, a network of users), such as a professional social network, which facilitates interactions among the users. Note that each of the users of the software application may have an associated user profile that includes personal and professional characteristics and experiences, which are sometimes collectively referred to as ‘attributes’ or ‘characteristics.’

For example, a user profile may include: demographic information (such as age and gender), geographic location, work industry for a current employer, a functional area (e.g., engineering, sales, consulting), seniority in an organization, employer size, education (such as schools attended and degrees earned), employment history (such as previous employers and the current employer), professional development, interest segments, groups that the user is affiliated with or that the user tracks or follows, a job title, additional professional attributes (such as skills), and/or inferred attributes (which may include or be based on user behaviors). Moreover, user behaviors may include: log-in frequencies, search frequencies, search topics, browsing certain web pages, locations (such as IP addresses) associated with the users, advertising or recommendations presented to the users, user responses to the advertising or recommendations, likes or shares exchanged by the users, interest segments for the likes or shares, and/or a history of user activities when using the social network. Furthermore, the interactions among the users may help define a social graph in which nodes correspond to the users and edges between the nodes correspond to the users' interactions, interrelationships, and/or connections.

In particular, when using the software application, the users may post content or data items in the social network (which are sometimes referred to as ‘user posts’), such as: text, pictures, video, graphics, documents or files, presentations, etc. In addition, the users may post comments on other users' posts and/or about other users (such as endorsing the skill of another user in a particular area or topic). For example, a user may indicate that they like a user post or may provide feedback about the user post (which is sometimes referred to as a ‘tag’ or an ‘annotation’). In general, user posts and/or comments may include: verbal, written, and/or recorded information. Note that the user posts or comments may be communicated to other users via the software application that executes in the environment of electronic devices 110.

Over time, via network 116, an activity engine 118 in system 100 may aggregate the user posts (such as user-posted content), the associated comments and, more generally, the user interactions with each other in the social network. Then, activity engine 118 may store the aggregated information in a data structure, which is stored in a computer-readable memory, such as storage system 122 that may encompass multiple devices, i.e., a large-scale storage system. Note that the user-posted content may include documents that include multiple pages (which are sometimes referred to as ‘sequential sets of content items’ that include multiple individual ‘content items’), such as: presentations that include slides, video that include frames, text files that include multiple pages, spreadsheets that include multiple sheets, websites with multiple web pages, etc. For example, a given document may include a subset of the pages in the documents. Moreover, the content in the documents may include: text, graphics, photographs or images, audio, video, etc.

Then, content engine 120 may create pointers specifying the pages in the documents. For example, content engine 120 may create content identifiers for some or all of the pages in a given document. A given content identifier may include a pointer to a page in a document, metadata associated with the page, keywords in the content in the page, and/or a presentation format of the content in the page (such as the font size, font color, positioning and highlighting of words or phrases in the document). The pointers may also specify a storage location in storage system 122 where the page is stored.

Moreover, the metadata may include: a name of the document, one or more annotations or tags associated with the document, and/or an author of the document (as specified by the author's name or an identifier of the author). Note that the content identifier may include a timestamp associated with the page, such as a time when the content identifier was created. As described further below, the content identifiers may allow the pages to be identified (such as using a search engine) without requiring that the pages be extracted from the documents.

Next, content engine 120 may aggregate the content identifiers into an index (or corpus) that is stored in storage system 122. The content identifiers in the index may be organized by (or be searchable or accessible based on): the keywords, the metadata, the presentation formats, and/or the timestamps.

Subsequently, a user of electronic device 110-1 may use the software application to identify and access the pages in the documents. In particular, the user may provide a search query using a user interface associated with the software application, which is displayed on electronic device 110-1. For example, the user may write, type or enter the search query into a text-entry box. Alternatively, the software application may use voice-recognition technology to receive the search query based on the user's spoken words. After receiving the search query, electronic device 110-1 provides it to search engine 124 via network 112, communication server 114 and network 116.

In response to the user's search query, search engine 124 in system 100 may conduct a search of the content identifiers in the index. In particular, based on the search query, search engine 124 may identify a match in the pointers in the index. For example, from the search query, search engine 124 may generate a search expression. Note that generating the search expression may involve eliminating articles, adding permutations of words and phrases, adding synonyms adding categories and/or other processing. Thus, a search expression for a search query of ‘the laptop computer’ may be ‘laptop OR computer OR laptop computer OR computer laptop OR portable computer OR personal computer OR computing machine,’ where OR is a logical or a Boolean OR operation (more generally, the search expression may include other logical or Boolean operations).

Then, search engine 124 may compare the search expression to the entries (such as the content identifiers) in the index. For each entry, a match score may be computed as the weighted sum matches of one or more words or phrases. For example, the match score may be the sum of instances of a product of a weight αᵢ (such 1) and a direct match Jᵢ of one or more words or phrases in the search expression and one or more words or phrases in the index (such as one or more keywords associated with a page), a product of a weight γᵢ (such as 0.5) and a match Kᵢ of one or more words or phrases in the search expression and one or more words or phrases in the index with at least one intervening word or phrase, a product of a weight βᵢ (such as −0.25) and a match Mᵢ of one or more words or phrases in the search expression and one or more words or phrases in the index with at least two intervening words or phrases, etc. Thus, an illustrative match score may be

$${\sum }_{i} {α}_{i} \cdot {J}_{i} + {γ}_{i} \cdot {K}_{i} + {β}_{i} \cdot {M}_{i} .$$

Next, search engine 124 may identify at least the match (or, more generally, a set of one or more matches) by comparing the match scores to a threshold value (such as 0.5), where the match is identified when the match score exceeds the threshold value. Alternatively or additionally, search engine 124 may identify at least the match (or, more generally, the set of one or more matches) by ranking the match scores, where the match is identified as one of a top N match scores in the ranking (such as one of the top 10 match scores).

Furthermore, search engine 124 may provide search results to electronic device 110-1, via network 116, communication server 114 and network 112, including a pointer in the index based on the match. For example, the user of electronic device 110-1 may click on or activate a link associated with the pointer, or may access a location in system 100 specified by the pointer (such as a location in storage subsystem 122) to view a page in a document. Thus, the pointer may allow the page in the document to be accessed while the page is included in the document. In some embodiments, the search results include the metadata and/or the keywords in the page in the document.

In these ways, the search technique may allow users to flexibly and efficiently access one or more pages in documents. Moreover, the content identifiers (and, in particular, the pointers) may facilitate storage of and searching for content with: reduced cost, delay and/or complexity. Consequently, the search technique may improve the user experience with system 100 and the social network. This may result in increased engagement with or use of the social network, and thus may increase the revenue of a provider of the social network.

Note that information in system 100 may be stored at one or more locations (i.e., locally and/or remotely). Moreover, because this data may be sensitive in nature, it may be encrypted. For example, stored data and/or data communicated via networks 112 and/or 116 may be encrypted.

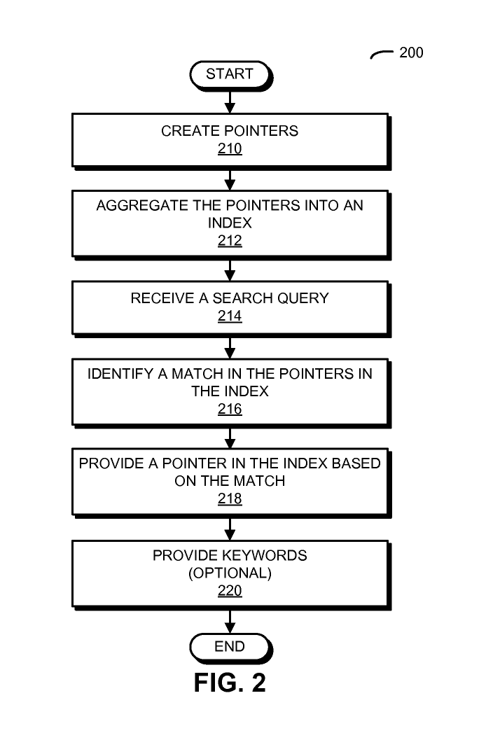

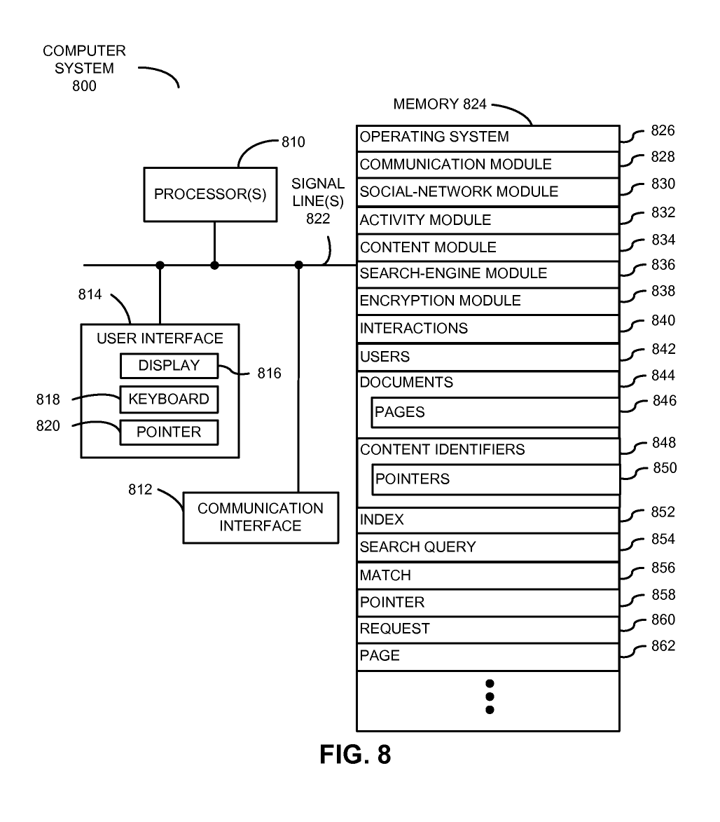

We now describe embodiments of the search technique as it may be conducted within a system that maintains the documents. FIG. 2 presents a flow chart illustrating a method 200 for searching for pages in documents, or for content that the pages include, which may be performed by a computer system (such as system 100 in FIG. 1 or computer system 800 in FIG. 8). During operation, the computer system creates pointers (operation 210) specifying the pages in the documents (such as slides in a presentation or frames in a video), where a given document includes a subset of the pages in the documents. Note that a given pointer specifies a storage location in the computer system where a given page is stored.

Then, the computer system aggregates the pointers in an index (operation 212). For example, the index may be aggregated based on: keywords in content of the pages, metadata associated with the pages (such as a name of the given document, annotations associated with the pages, and/or an author of the given document), and/or presentation formats of the pages.

Moreover, the computer system receives a search query (operation 214). Next, the computer system identifies a match in the pointers in the index (operation 216) based on the search query. For example, identifying the match may involve: generating a search expression based on the search query (such as a search expression that includes synonyms of the search query); determining match scores for the search query with keywords in the pages in the documents specified by the pointers; and comparing the match scores to a threshold value, where the match is identified when the match score exceeds the threshold value. Alternatively, identifying the match may involve: generating a search expression based on the search query (such as a search expression that includes synonyms of the search query); determining match scores for the search query with keywords in the pages in the documents specified by the pointers; and ranking the match scores, where the match is identified as one of a top N pointers in the ranking.

Furthermore, the computer system provides one or more pointers in the index based on the match (operation 218), where a pointer allows a corresponding page in a document to be accessed while the page is included in the document.

In some embodiments, the computer system optionally provides keywords (operation 220) from the document. For example, the computer system may provide 3-10 keywords found in the corresponding pages and/or elsewhere in the document. These keywords may be associated with titles, categories and/or sub-categories in the document as determined based on the presentation format of the document. In particular, keywords may be identified based on font size, font color, positioning (such as offset). highlighting (such as bold or underlined) of words or phrases in the document, and/or other distinguishing characteristics, which allow the computer system to identify titles, categories, and/or sub-categories in the document.

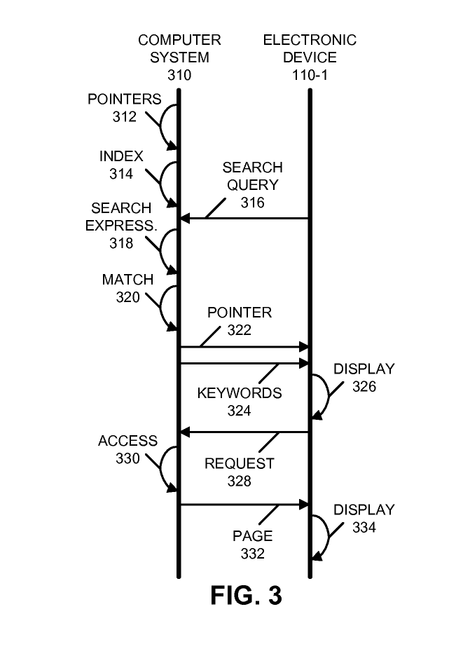

In an exemplary embodiment, method 200 is implemented using one or more electronic devices and at least one server (and, more generally, a computer system), which communicate through a network, such as a cellular-telephone network and/or the Internet (e.g., using a client-server architecture). This is illustrated in FIG. 3. During this method, computer system 310 (which may implement some or all of the functionality of system 100 in FIG. 1) may create pointers 312 specifying the pages in the documents. Then, computer system 310 may aggregate pointers 312 in an index 314.

Subsequently, a user of electronic device 110-1 may provide a search query 316 to computer system 310. In response, computer system 310 may optionally generate search expression 318 from search query 316, and may identify a match 320 among pointers 312 in index 314 based on search expression 318.

Furthermore, computer system 310 may provide to electronic device 110-1 a pointer 322 in index 314 based on match 320, where pointer 322 allows a page in a document to be accessed while the page remains part of the document. In some embodiments, computer system 310 also provides to electronic device 110-1 keywords 324 (and, more generally, additional information) in or associated with the page in the document.

Next, electronic device 110-1 may display 326 pointer 322 and/or keywords 324. If the user activates a link that includes pointer 322, electronic device 110-1 may request 328 the page (or information specifying the page). In response, computer system 310 may access 330 the page and provide instructions for or an image of the page 332 to electronic device 110-1, which displays 334 this information.

In some embodiments of method 200 (FIGS. 2 and 3), there may be additional or fewer operations. Moreover, the order of the operations may be changed, and/or two or more operations may be combined into a single operation.

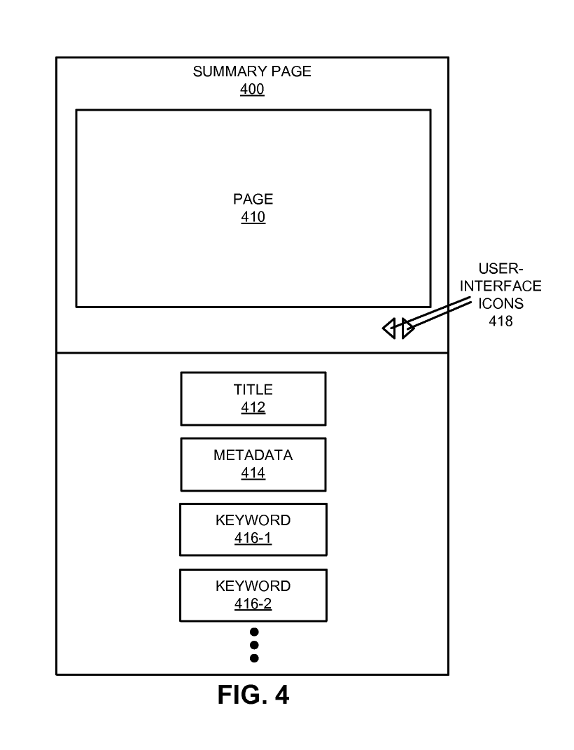

In an exemplary embodiment, when a user conducts a search of content identifiers using the search technique, the computer system presents search results to the user via a summary page. This is shown in FIG. 4, which illustrates a summary page 400 summarizing search results, such as a page 410 in a document. This summary page may include a title 412, metadata 414 and keywords 416 in page 410.

As noted previously, title 412 and/or keywords 416 may be identified based on a presentation format of page 410. In addition, title 412 and/or keywords 416 may be identified based on content in page 410 using natural language processing.

Summary page 400 may enable access to additional pages. Thus, if the user activates one of user-interface icons 418, a preceding or a following page in the same document, or a page corresponding to another content identifier in the set of identifiers uncovered during the search, may be displayed in summary page 400.

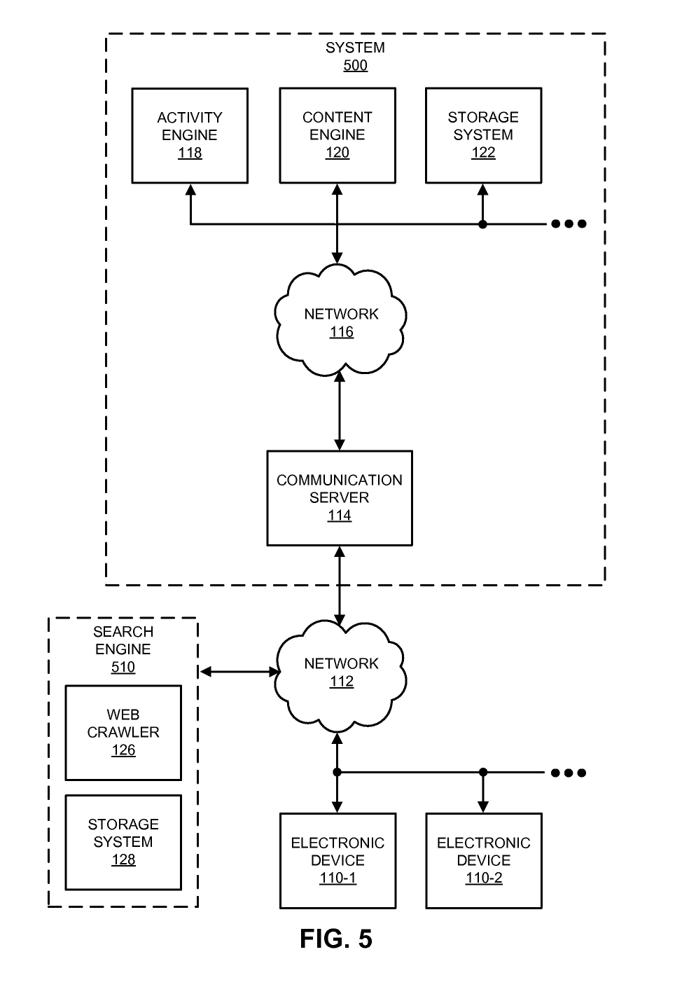

While the preceding embodiments illustrated the use of the search technique within system 100 (FIG. 1) and the social network, in other embodiments the search technique is implemented by a third party (such as a provider of a search engine), as opposed to by the provider of system 100 (FIG. 1) and the social network (i.e., the search engine is external to the system). This is shown in FIG. 5, which presents a block diagram illustrating a system 500 that performs the search technique. Once again, in this system users of electronic devices 110 may use the software product to interact with other users in the social network (and, more generally, the network of users). In particular, when using the software application, the users may post content or data items in the social network (such as: text, pictures, video, graphics, documents or files, presentations, etc.), as well as comments on other users' posts and/or about other users (such as endorsing the skill of another user in a particular area or topic).

Over time, via network 116, activity engine 118 in system 500 may aggregate the user posts (such as user-posted content), the associated comments and, more generally, user interactions with each other in the social network. Then, activity engine 118 may store the aggregated information in a data structure, which is stored in storage system 122. Note that the user-posted content may include the documents that include multiple pages, such as: presentations that include slides, video that includes frames, text files that include multiple pages, spreadsheets that include multiple sheets, websites with web pages, etc. For example, a given document may include a subset of the pages in the documents. Moreover, the content in the documents may include: text, graphics, photographs or images, audio, video, etc.

Then, content engine 120 may create pointers specifying the pages in the documents. For example, content engine 120 may create content identifiers for the pages in the documents. A given content identifier may include a pointer to a page in a document, metadata associated with the page, keywords in the content in the page, and/or a presentation format of the content in the page (such as the font size, font color, positioning and highlighting of words or phrases in the document).

The pointers may specify a storage location in storage system 122 where the page is stored. The metadata may include: a name of the document, one or more annotations or tags associated with the document, and/or an author of the document (as specified by the author's name or an identifier of the author). Note that the content identifier may include a timestamp associated with the page, such as a time when the content identifier was created. As described further below, the content identifiers may allow the pages to be identified (such as using a search engine) without requiring that the pages be extracted from the documents.

Next, content engine 120 may provide one or more hypertext documents (such as one or more web pages or websites) that include information associated with the content identifiers. For example, the content identifiers may be associated with links that are included in and that are visible in the one or more web pages. Alternatively or additionally, the information associated with the content identifiers may not be visible in the one or more web pages. Instead, the information associated with the content identifiers may be included in the background or tiled into the one or more web pages.

Moreover, information associated with the content identifiers may be included in the one or more web pages as rich media. In some embodiments, information associated with the content identifiers is included in an address of the one or more web pages (such as a uniform resource locator for a given web page). Note that different web pages may include subsets of the information associated with the content identifiers, e.g., based on the title, metadata, the presentation formats and/or keywords associated with the pages. Thus, information associated with the content identifiers for particular or related topics may be included in the same web page.

System 500 may allow the one or more web pages to be accessed from outside of system 500 or the social network. For example, search engine 510 may identify the one or more web pages via network 112, communication server 114 and network 116. Then, a web crawler 126 in search engine 510 may ingest at least some of the information associated with the content identifiers from the one or more web pages. For example, web crawler 126 may ingest the pointers that specify the pages in the documents from the one or more web pages.

Next, search engine 510 may aggregate the ingested pointers in an index, which is stored in a data structure in a computer-readable memory included in or accessible by search engine 510. For example, search engine 510 may aggregate the information associated with the content identifiers into an index (or corpus) that is stored in storage system 128. The content identifiers in the index may be organized by (or searchable or accessible based on): the keywords, the metadata, the presentation formats, and/or the timestamps.

Subsequently, users of electronic devices 110 may use a search software application to conduct searches of the content in the pages in the documents. Instances of this search software application may be resident on and execute on electronic devices 110. In some implementations, the users may interact with a web page that is provided by search engine 510 (such as a server in search engine 510) via network 112, and which is rendered by web browsers on electronic devices 110. For example, at least a portion of the search software application executing on electronic devices 110 may be an application tool that is embedded in the web page, and that executes in a virtual environment of the web browsers. Thus, the application tool may be provided to the users via a client-server architecture.

The search software application operated by the users may be a standalone application or a portion of another application that is resident on and that executes on electronic devices 110 (such as a software application that is provided by search engine 510 or that is installed on and that executes on electronic devices 110).

Using one of electronic devices 110 (such as electronic device 110-1) as an illustrative example, a user of electronic device 110-1 may use the search software application to identify and access the pages in the documents. In particular, the user may provide a search query using a user interface associated with the search software application, which is displayed on electronic device 110-1. For example, the user may write, type or enter the search query into a text-entry box. Alternatively, the search software application may use voice-recognition technology to receive the search query based on the user's spoken words. After receiving the search query, electronic device 110-1 provides it to search engine 510 via network 112.

In response to the user's search query, search engine 510 may conduct a search of the content identifiers in the index. This search may be configured and executed as described previously for search engine 124 (FIG. 1), and may identify the match in the index.

Furthermore, search engine 510 may provide, via network 112, search results, including a pointer in the index based on the match to electronic device 110-1 that allows the user to access the page stored in or by system 500. For example, the user of electronic device 110-1 may click on or activate a link associated with the pointer, or may access a location in system 500 specified by the pointer (such as a location in storage subsystem 122) to view a page in a document. Thus, the pointer may allow the page in the document to be accessed while the page is included in the document. In some embodiments, the search results include the metadata and/or the keywords in the page in the document.

In these ways, the search technique may allow users to flexibly and efficiently access one or more pages in documents, even though the pages are included in the documents, and the documents are stored in or by system 500 (as opposed to by a provider of search engine 510). Consequently, the search technique may improve the user experience with search engine 510, system 500 and the social network. This may result in increased engagement with or use of the search engine 510 and the social network, and thus may increase the revenue of a provider of search engine 510 and the social network.

Note that information in system 500 may be stored at one or more locations (i.e., locally and/or remotely). Moreover, because this data may be sensitive in nature, it may be encrypted. For example, stored data and/or data communicated via networks 112 and/or 116 may be encrypted.

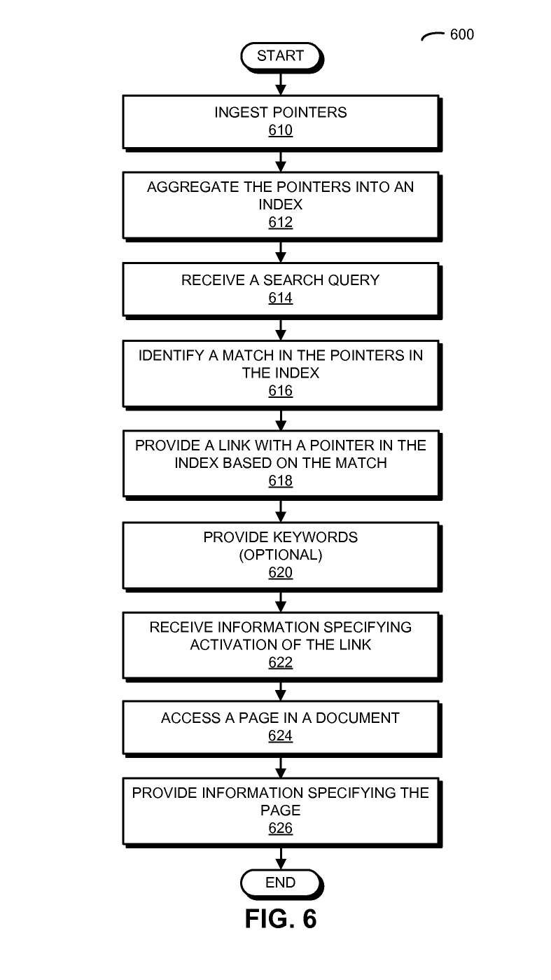

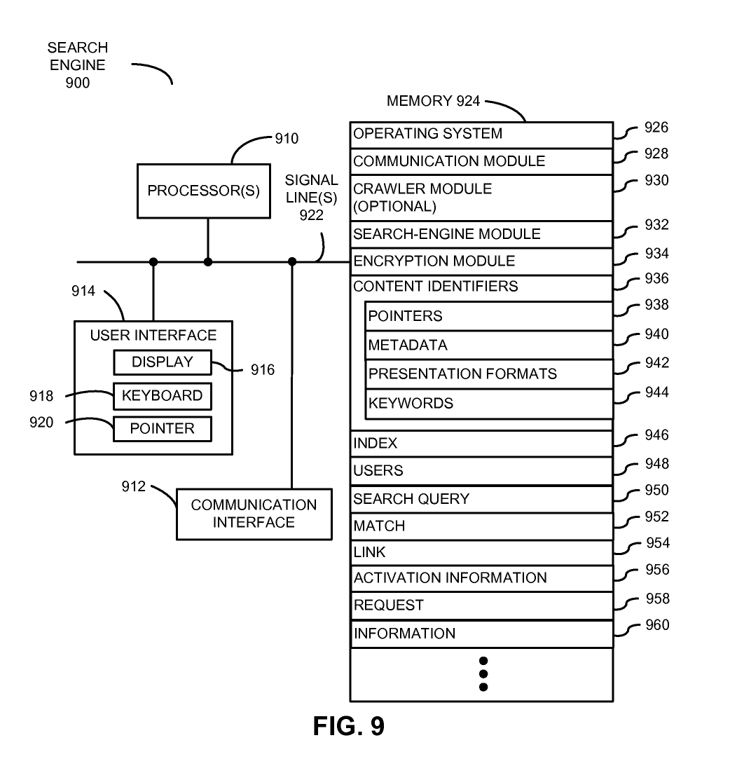

We now describe embodiments of the search technique in which the search engine is external to a system that maintains the documents. FIG. 6 presents a flow chart illustrating a method 600 for searching for pages in documents, which may be performed by a computer system (such as search engine 510 in FIG. 5 or search engine 900 in FIG. 9). During operation, the computer system ingests pointers (operation 610) that specify the pages in the documents (such as slides in a presentation or frames in a video) from hypertext documents on a network, where a given document includes a subset of the pages in the documents. Note that a given pointer specifies a storage location where a corresponding page is stored. This storage location is in another computer system (such as system 500 in FIG. 5).

Then, the computer system aggregates the ingested pointers in an index (operation 612). For example, the index may be aggregated based on: keywords in content of the pages, metadata associated with the pages (such as a name of the given document, annotations associated with the pages, and/or an author of the given document), and/or presentation formats of the pages.

Moreover, the computer system receives a search query (operation 614). Next, the computer system identifies a match in the pointers (operation 616) within the index based on the search query. For example, identifying the match may involve: generating a search expression based on the search query (such as a search expression that includes synonyms of the search query); determining match scores for the search query with keywords in the pages in the documents specified by the pointers; and comparing the match scores to a threshold value, where the match is identified when the match score exceeds the threshold value. Alternatively, identifying the match may involve: generating a search expression based on the search query (such as a search expression that includes synonyms of the search query); determining match scores for the search query with keywords in the pages in the documents specified by the pointers; and ranking the match scores, where the match is identified as one of a top N pointers in the ranking.

Furthermore, the computer system provides a link with a pointer in the index based on the match (operation 618), where the pointer allows a page in a document to be accessed without extracting it from the document. In some embodiments, the computer system optionally provides keywords (operation 620) from the page in the document and/or from other parts of the document.

After receiving information specifying activation of the link (operation 622), the computer system may access a page in a document (operation 624) associated with a hypertext document, where the page is included in the document. Then, the computer system may provide information specifying the page (operation 626).

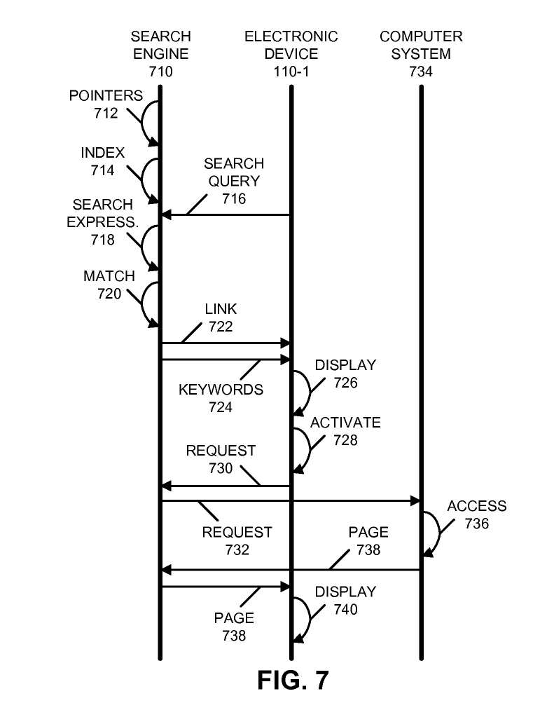

In an exemplary embodiment, method 600 is implemented using one or more electronic devices and at least one server (and, more generally, a computer system), which communicate through a network, such as a cellular-telephone network and/or the Internet (e.g., using a client-server architecture). This is illustrated in FIG. 7. During this method, search engine 710 (which may implement some or all of the functionality of search engine 510 in FIG. 5) may ingest pointers 712 specifying the pages in the documents from a hypertext document (such as a web page or a website). Then, search engine 710 may aggregate pointers 712 in an index 714.

Subsequently, a user of electronic device 110-1 may provide a search query 716 to search engine 710. In response, search engine 710 may optionally generate search expression 718 from search query 716, and may identify a match 720 in pointers 712 in index 714 based on search expression 718.

Furthermore, search engine 710 may provide to electronic device 110-1 a link 722 with a pointer in index 714 based on match 720, where the pointer allows a page in a document to be accessed without separating it from the document. In some embodiments, search engine 710 also provides to electronic device 110-1 keywords 724 in the page in the document.

Next, electronic device 110-1 may display 726 link 722 and/or keywords 724. If the user activates 728 link 722 that includes the pointer, electronic device 110-1 may request 730 information specifying the page from search engine 710. In response, search engine 710 may request 732 the information specifying the page from computer system 734 (which may implement some or all of the functionality of system 500 in FIG. 5). Then, computer system 734 may access 736 the page and may provide instructions for or an image of page 738 to search engine 710. This information is then provided to electronic device 110-1, which displays 740 it.

In some embodiments of method 600 (FIGS. 6 and 7), there may be additional or fewer operations. Moreover, the order of the operations may be changed, and/or two or more operations may be combined into a single operation. Note that in some embodiments, the modification made by at least some of the experts to the topic content and/or the presentation formats are anonymous.

We now describe embodiments of a computer system for performing the search technique and its use. In these embodiments, the search technique is performed by the computer system to locate pages of documents maintained by the computer system.

FIG. 8 presents a block diagram illustrating a computer system 800 that performs at least some of the operations in method 200 (FIGS. 2 and 3) or method 600 (FIGS. 6 and 7), such as system 100 in FIG. 1, computer system 310 in FIG. 3, system 500 in FIG. 5, and computer system 734 in FIG. 7. Computer system 800 includes one or more processing units or processors 810 (which are sometimes referred to as a ‘processing module’), a communication interface 812, a user interface 814, memory 824, and one or more signal lines 822 coupling these components together. Note that the one or more processors 810 may support parallel processing and/or multi-threaded operation, the communication interface 812 may have a persistent communication connection, and the one or more signal lines 822 may constitute a communication bus. Moreover, the user interface 814 may include: a display 816 (such as a touchscreen), a keyboard 818, and/or a pointer 820 (such as a mouse).

Memory 824 in computer system 800 may include volatile memory and/or non-volatile memory. More specifically, memory 824 may include: ROM, RAM, EPROM, EEPROM, flash memory, one or more smart cards, one or more magnetic disc storage devices, and/or one or more optical storage devices. Memory 824 may store an operating system 826 that includes procedures (or a set of instructions) for handling various basic system services for performing hardware-dependent tasks. Memory 824 may also store procedures (or a set of instructions) in a communication module 828. These communication procedures may be used for communicating with one or more computers and/or servers, including computers and/or servers that are remotely located with respect to computer system 800.

Memory 824 may also include multiple program modules (or sets of instructions), including: social-network module 830 (or a set of instructions), activity module 832 (or a set of instructions), content module 834 (or a set of instructions), search-engine module 836 (or a set of instructions), and/or encryption module 838 (or a set of instructions). Note that one or more of these program modules (or sets of instructions) may constitute a computer-program mechanism.

During operation of computer system 800, social-network module 830 facilitates interactions 840 among users 842 via communication module 828 and communication interface 812. These interactions may be tracked by activity module 832, and may include user posts and associated comments. For example, the user posts may include documents 844 with pages 846. Then, content module 834 may create content identifiers 848, with pointers 850 specifying pages 846 in documents 844. Moreover, content module 834 may optionally aggregate pointers 850 in an index 852.

Subsequently, search-engine module 836 may receive, via communication interface 812 and communication module 828, from one of users 842 a search query 854. Next, search-engine module 836 may identify at least a match 856 in pointers 850 in index 852 based on search query 854. Furthermore, search-engine module 836 may provide, via communication module 828 and communication interface 812, a pointer 858 in index 852 based on match 856, where pointer 858 allows a page in a document to be accessed while the page is included in the document. If search-engine module 836 receives, via communication interface 812 and communication module 828, a request 860 from the user for information specifying page 862 associated with pointer 858, search-engine module 836 may access information specifying page 862 (such as instructions for page 862 or an image of page 862), and may provide this information to the user via communication module 828 and communication interface 812.

Because information in computer system 800 may be sensitive in nature, in some embodiments at least some of the data stored in memory 824 and/or at least some of the data communicated using communication module 828 is encrypted using encryption module 838.

FIG. 9 presents a block diagram illustrating a search engine 900 that performs at least some of the operations in method 200 (FIGS. 2 and 3) or method 600 (FIGS. 6 and 7), such as search engine 510 in FIG. 5. In the illustrated embodiment, the search engine performs a search technique disclosed herein to locate pages of documents stored on one or more systems remote from the search engine.

Search engine 900 includes one or more processing units or processors 910 (which are sometimes referred to as a ‘processing module’), a communication interface 912, a user interface 914, memory 924, and one or more signal lines 922 coupling these components together. Note that the one or more processors 910 may support parallel processing and/or multi-threaded operation, the communication interface 912 may have a persistent communication connection, and the one or more signal lines 922 may constitute a communication bus. Moreover, the user interface 914 may include: a display 916 (such as a touchscreen), a keyboard 918, and/or a pointer 920 (such as a mouse).

Memory 924 in search engine 900 may include volatile memory and/or non-volatile memory. More specifically, memory 924 may include: ROM, RAM, EPROM, EEPROM, flash memory, one or more smart cards, one or more magnetic disc storage devices, and/or one or more optical storage devices. Memory 924 may store an operating system 926 that includes procedures (or a set of instructions) for handling various basic system services for performing hardware-dependent tasks. Memory 924 may also store procedures (or a set of instructions) in a communication module 928. These communication procedures may be used for communicating with one or more computers and/or servers, including computers and/or servers that are remotely located with respect to search engine 900.

Memory 924 may also include multiple program modules (or sets of instructions), including: optional crawler module 930 (or a set of instructions), search-engine module 932 (or a set of instructions), and/or encryption module 934 (or a set of instructions). Note that one or more of these program modules (or sets of instructions) may constitute a computer-program mechanism.

During operation of search engine 900, optional crawler module 930 may ingest (e.g., from one or more hypertext documents on a network via communication module 928 and communication interface 912) information associated with content identifiers 936 for pages in documents, such as pointers 938 and/or additional information (e.g., metadata 940, presentation formats 942 and/or keywords 944 in content in the pages). Alternatively, search engine 900 may already have access to content identifiers 936 without scraping the one or more hypertext documents.

Then, search-engine module 932 may aggregate the information associated with content identifiers 936 in an index 946.

Subsequently, search-engine module 932 may receive, via communication interface 912 and communication module 928, from one of users 948 a search query 950. Next, search-engine module 932 may identify at least a match 952 in pointers 938 in index 946 based on search query 950. Furthermore, search-engine module 932 may provide, via communication module 928 and communication interface 912, a link 954 to a pointer in index 946 based on match 952, where the pointer allows a page in a document to be accessed while the page is included in the document.

If search-engine module 932 receives, via communication interface 912 and communication module 928, activation information 956 of link 954 to the pointer by the one of users 948, search-engine module 932 may provide, via communication module 928 and communication interface 912, a request 958 for information specifying the page or an image of the page to a remote storage location (such as a storage location associated with computer system 800 in FIG. 8). After receiving the requested information 960 from the remote storage location, via communication interface 912 and communication module 928, search-engine module 932 may provide this information to the one of users 948 via communication module 928 and communication interface 912.

Because information in search engine 900 may be sensitive in nature, in some embodiments at least some of the data stored in memory 924 and/or at least some of the data communicated using communication module 928 is encrypted using encryption module 934.

Instructions in the various modules in memory 824 (FIG. 8) and/or 924 may be implemented in a high-level procedural language, an object-oriented programming language, and/or in an assembly or machine language. Note that the programming language may be compiled or interpreted, e.g., configurable or configured, to be executed by the one or more processors.

Although computer system 800 (FIG. 8) and/or search engine 900 are illustrated as having a number of discrete items, FIGS. 8 and 9 are intended to be a functional description of the various features that may be present in computer system 800 (FIG. 8) and/or search engine 900 rather than a structural schematic of the embodiments described herein. In practice, and as recognized by those of ordinary skill in the art, the functions of computer system 800 (FIG. 8) and/or search engine 900 may be distributed over a large number of servers or computers, with various groups of the servers or computers performing particular subsets of the functions. In some embodiments, some or all of the functionality of computer system 800 (FIG. 8) and/or search engine 900 are implemented in one or more application-specific integrated circuits (ASICs) and/or one or more digital signal processors (DSPs).

Computer systems (such as computer system 800 in FIG. 8), as well as electronic devices, computers and servers in system 100 (FIG. 1), system 500 (FIG. 5), search engine 510 (FIG. 5) and search engine 900, may include one of a variety of devices capable of manipulating computer-readable data or communicating such data between two or more computing systems over a network, including: a personal computer, a laptop computer, a tablet computer, a mainframe computer, a portable electronic device (such as a cellular phone or PDA), a server and/or a client computer (in a client-server architecture). Moreover, network 112 (FIGS. 1 and 5) may include: the Internet, World Wide Web (WWW), an intranet, a cellular-telephone network, LAN, WAN, MAN, or a combination of networks, or other technology enabling communication between computing systems.

System 100 (FIG. 1), system 500 (FIG. 5) and search engine 510 (FIG. 5), computer system 800 (FIG. 8) and/or search engine 900 may include fewer components or additional components. Moreover, two or more components may be combined into a single component, and/or a position of one or more components may be changed. In some embodiments, the functionality of system 100 (FIG. 1), system 500 (FIG. 5) and search engine 510 (FIG. 5), computer system 800 (FIG. 8) and/or search engine 900 may be implemented more in hardware and less in software, or less in hardware and more in software, as is known in the art.

While a social network has been used as an illustration in the preceding embodiments, more generally the search technique may be used to index and search content in a wide variety of applications or systems. Moreover, the search technique may be used in applications where the communication or interactions among different entities (such as people, organizations, etc.) can be described by a social graph. Note that the people may be loosely affiliated with a website (such as viewers or users of the website), and thus may include people who are not formally associated (as opposed to the users of a social network who have user accounts). Thus, the connections in the social graph may be defined less stringently than by explicit acceptance of requests by individuals to associate or establish connections with each other, such as people who have previously communicated with each other (or not) using a communication protocol, or people who have previously viewed each other's home pages (or not), etc. In this way, the search technique may be used to expand the quality of interactions and value-added services among relevant or potentially interested people in a more loosely defined group of people. In some embodiments, the search technique is used in applications where the documents are provided by individuals that are not related or interacting loosely or more formally.

Thus, the search technique may be used to index and search documents in applications where there does not have to be communication or interactions among different entities (such as people, organizations, etc.). For example, instead of scraping the pointers from one or more hypertext documents, the search engine associated with a search-engine provider (who is other than the provider of the social network) may store the documents and the pages, and may generate or create the content identifiers (including the pointers). Then, when processing search queries or requests for particular pages in the documents (such as requests based on activation of links that include the pointers), the search engine may access the pages at storage locations in or associated with the search engine that are specified by the pointers.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer-system-implemented method for searching pages in documents, the method comprising:
scraping pointers that specify multiple pages in a plurality of corresponding remote documents on a network, wherein a given document includes a subset of the multiple pages;
aggregating the ingested pointers in an index;
receiving a search query;
using the computer system, identifying a match in the pointers in the index based on the search query;
providing a link with a pointer in the index based on the match;
receiving information specifying activation of the link;
accessing a page in a corresponding remote document without extracting the page from the corresponding document; and
providing information specifying the page.

2. The method of claim 1, wherein the index is aggregated based on keywords in content of the pages.

3. The method of claim 1, wherein the index is aggregated based on metadata associated with the pages.

4. The method of claim 3, wherein the metadata associated with a given page includes at least one of: a name of the corresponding document, one or more annotations associated with the given page, and an author of the corresponding document.

5. The method of claim 1, wherein the index is aggregated based on presentation formats of the pages.

6. The method of claim 1, wherein the given document includes one of: slides in a presentation, and frames in a video.

7. The method of claim 1, wherein the pointer specifies a storage location in a remote computer system where the page is stored.

8. The method of claim 1, wherein identifying the match involves:
generating a search expression based on the search query;
determining match scores for the search query with keywords in the pages in the documents specified by the pointers; and
comparing the match scores to a threshold value, wherein the match is identified when the match score exceeds the threshold value.

9. The method of claim 8, wherein the search expression includes synonyms of phrases in the search query.

10. The method of claim 1, wherein identifying the match involves:
generating a search expression based on the search query;
determining match scores for the search query with keywords in the pages in the documents specified by the pointers; and
ranking the match scores, wherein the match is identified as one of a top N match scores in the ranking.

11. The method of claim 10, wherein the search expression includes synonyms of phrases in the search query.

12. The method of claim 11, wherein the method further comprises providing keywords in the page in the corresponding document.

13. An apparatus, comprising:
one or more processors;
memory; and
a program module, wherein the program module is stored in the memory and, during operation of the apparatus, is executed by the one or more processors to search pages in documents, the program module including:
instructions for scraping pointers that specify multiple pages in a plurality of corresponding remote documents on a network, wherein a given document includes a subset of the multiple pages;
instructions for aggregating the ingested pointers in an index;
instructions for receiving a search query;
instructions for identifying a match in the pointers in the index based on the search query;
instructions for providing a link with a pointer in the index based on the match;
instructions for receiving information specifying activation of the link;
instructions for accessing a page in a corresponding remote document without extracting the page from the corresponding document; and
instructions for providing information specifying the page.

14. The apparatus of claim 13, wherein the index is aggregated based on at least one of: keywords in content of the pages; metadata associated with the pages; and presentation formats of the pages.

15. The apparatus of claim 14, wherein the metadata associated with a given page includes at least one of: a name of the corresponding document, one or more annotations associated with the given page, and an author of the corresponding document.

16. The apparatus of claim 13, wherein the given document includes one of: slides in a presentation, and frames in a video.

17. The apparatus of claim 13, wherein the pointer specifies a storage location where the page is stored.

18. The apparatus of claim 13, wherein the instructions for identifying the match involve:
generating a search expression based on the search query;
determining match scores for the search query with keywords in the pages in the documents specified by the pointers; and
comparing the match scores to a threshold value, wherein the match is identified when the match score of exceeds the threshold value.

19. The apparatus of claim 13, wherein the instructions for identifying the match involve:
generating a search expression based on the search query;
determining match scores for the search query with keywords in the pages in the documents specified by the pointers; and
ranking the match scores, wherein the match is identified as one of a top N match scores in the ranking.

20. A system, comprising:
a processing module comprising a non-transitory computer-readable medium storing instructions that, when executed, cause the system to:
ingest pointers that specify multiple pages in a plurality of corresponding remote documents on a network, wherein a given document includes a subset of the multiple pages;
aggregate the ingested pointers in an index;
receive a search query;
identify a match in the pointers in the index based on the search query;
provide a link with a pointer in the index based on the match;
receive information specifying activation of the link;
access a page in a corresponding remote document without extracting the page from the corresponding document; and
provide information specifying the page.
